(19) United States
(12) Patent Application Publication
(10) Pub. No.: US 2010/0194724 A1
(43) Pub. Date: Aug. 5, 2010

(54) LIQUID CRYSTAL DISPLAY DEVICE

(75) Inventor: Takayuki OTA, Oamishirasato (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi Displays, Ltd.

(21) Appl. No.: 12/696,079

(22) Filed: Jan. 29, 2010

(30) Foreign Application Priority Data
Feb. 3, 2009 (JP) 2009-022153
Jul. 31, 2009 (JP) 2009-178609

(51) Int. Cl. G09G 3/36; G02F 1/1333; G02F 1/13357

(52) U.S. Cl. 345/207; 349/58; 349/67; 349/70

(57) ABSTRACT

A liquid crystal display device comprises a liquid crystal display panel; and a backlight. The backlight includes: a plurality of fluorescent lamps arranged in parallel in a plane parallel to the liquid crystal display panel; a housing for supporting each of the plurality of fluorescent lamps; and a plurality of blue light emitting elements each disposed between the housing and the plane in which the plurality of fluorescent lamps are arranged in parallel. The plurality of blue light emitting elements are arranged at positions overlapped with the plurality of fluorescent lamps when projected onto a plane parallel to a surface of the liquid crystal display panel from a direction perpendicular to the surface of the liquid crystal display panel, to thereby prevent yellowing from occurring in white color tone of the backlight.

### CROSS-REFERENCE TO RELATED APPLICATION

The present application claims priority from Japanese applications JP 2009-022153 filed on Feb. 3, 2009 and JP 2009-178609 filed on Jul. 31, 2009, the contents of which are hereby incorporated by reference into this application.

### BACKGROUND OF THE INVENTION

1. Field of the Invention

The present invention relates to a liquid crystal display device, and more particularly, to a liquid crystal display device including a liquid crystal display panel and a backlight disposed on a back surface of the liquid crystal display panel.

2. Description of the Related Art

A liquid crystal display panel is formed so that light transmittances of pixels formed therein may be individually controlled, and hence the liquid crystal display panel generally includes a backlight disposed on a back surface of the liquid crystal display panel.

A known example of such backlight is called “direct type backlight”.

As disclosed in JP 06-75216 A, for example, the direct type backlight has the following structure. That is, a plurality of light sources such as cold cathode fluorescent lamps are arranged in parallel in a plane parallel to the liquid crystal display panel. The cold cathode fluorescent lamps are supported by a housing (frame) having a reflection sheet or the like disposed on its inner surface.

Further, JP 2007-214053 A discloses a backlight including, as light sources in addition to the cold cathode fluorescent lamps, a plurality of light emitting elements that emit red light, green light, and blue light. When viewed in plan, the light emitting elements are mounted so as to be arranged side by side in each region between the cold cathode fluorescent lamps. A light receiving sensor disposed at substantially the center of the backlight measures light intensity. Then, based on a result of the measurement, color correction is performed so that the light emitted from the light emitting elements may be maintained to be white light.

Still further, JP 2007-133407 A discloses a backlight of not direct type but so-called edge-light type having the following structure. That is, the backlight includes a light guide plate, cold cathode fluorescent lamps, and light emitting elements that emit red light. The cold cathode fluorescent lamps and the light emitting elements are disposed on each side wall surface of a pair of opposed sides of the light guide plate. The deviation toward green and blue of the cold cathode fluorescent lamp is corrected with the light emitting element.

### SUMMARY OF THE INVENTION

However, a phenomenon of yellowing in its white color tone occurs through the use of the direct type backlight as described above. This is because the cold cathode fluorescent lamp used in the direct type backlight is affected by ultraviolet rays or heat generated from the cold cathode fluorescent lamp during applying current, then the yellowing occurs in the white color tone.

Accordingly, even in an image display on the liquid crystal display panel recognized through transmission of light from the backlight, yellowing eventually occurs in a portion to be displayed in white.

Even in the technology disclosed in JP 2007-214053 A, the structure is employed in which, in addition to the cold cathode fluorescent lamps, the respective light emitting elements of red, green, and blue serve as the light sources, and the light emitted from the light emitting elements of the respective colors is maintained to be white light, which does not aim to solve the problem of yellowing occurring in white color tone of the cold cathode fluorescent lamp.

Also in the technology disclosed in JP 2007-133407 A, the structure is employed in which the red light emitting elements are arranged side by side with the cold cathode fluorescent lamps so that the deviation toward green and blue of the cold cathode fluorescent lamp may be corrected with the light emitting elements, which does not aim to solve the problem of yellowing occurring in white color tone of the cold cathode fluorescent lamp.

It is an object of the present invention to provide a liquid crystal display device in which yellowing may be prevented from occurring in white color tone of a backlight.

According to the liquid crystal display device of the present invention, yellowing of a fluorescent lamp of the backlight is suppressed by light emission of a blue light emitting element.

A structure of the present invention is, for example, as follows.

(1) A liquid crystal display device according to the present invention includes: a liquid crystal display panel which seals liquid crystal composition therein and controls orientations of the liquid crystal composition; and a backlight disposed on a side of one surface of the liquid crystal display panel, for emitting light toward the liquid crystal display panel, the backlight including: a plurality of fluorescent lamps arranged in parallel in a plane parallel to the liquid crystal display panel; a housing for supporting each of the plurality of fluorescent lamps; and a plurality of blue light emitting elements each disposed between the housing and the plane in which the plurality of fluorescent lamps are arranged in parallel, and the plurality of blue light emitting elements are arranged at positions overlapped with the plurality of fluorescent lamps when projected onto a plane parallel to the plane in which the plurality of fluorescent lamps are arranged in parallel.

(2) The liquid crystal display device according to item (1) of the present invention further includes a reflection sheet disposed on a surface of the housing on a side of the liquid crystal display panel, and each of the plurality of blue light emitting elements is disposed on the reflection sheet.

(3) The liquid crystal display device according to item (1) of the present invention further includes a reflection sheet disposed on a surface of the housing on a side of the liquid crystal display panel, each of the plurality of blue light emitting elements is disposed on an upper surface of the housing, and the reflection sheet has holes formed therein at portions opposed to the plurality of blue light emitting elements.

(4) The liquid crystal display device according to item (1) of the present invention further includes: an optical sensor capable of detecting color of light having passed through the liquid crystal display panel from the backlight; and a control circuit for controlling a light emission amount of each of the plurality of blue light emitting elements in accordance with an output of the optical sensor.

(5) In the liquid crystal display device according to item (4) of the present invention, the control circuit controls the light emission amount of the each of the plurality of blue light emitting elements through setting of a duty ratio of high frequency voltage.

(6) In the liquid crystal display device according to item (4) of the present invention, the control circuit controls a light emission amount of the each of the plurality of fluorescent lamps through setting of a duty ratio of high frequency voltage.

(7) The liquid crystal display device according to item (1) of the present invention further includes: an optical sensor which is mounted on the housing and is capable of detecting color of light from the each of the plurality of fluorescent lamps; and a control circuit for controlling a light emission amount of each of the plurality of blue light emitting elements in accordance with an output of the optical sensor.

(8) In the liquid crystal display device according to item (7) of the present invention, the control circuit controls the light emission amount of the each of the plurality of blue light emitting elements through setting of a duty ratio of high frequency voltage.

(9) In the liquid crystal display device according to item (7) of the present invention, the control circuit controls a light emission amount of the each of the plurality of fluorescent lamps through setting of a duty ratio of high frequency voltage.

(10) In the liquid crystal display device according to item (1) of the present invention, the liquid crystal display panel includes a liquid crystal display panel for color display.

(11) In the liquid crystal display device according to item (1) of the present invention, the liquid crystal display panel includes a liquid crystal display panel for monochrome display.

(12) In the liquid crystal display device according to item (1) of the present invention, a light output direction of each of the plurality of blue light emitting elements is a direction in which the liquid crystal display panel is disposed.

(13) In the liquid crystal display device according to item (1) of the present invention, a light output direction of each of the plurality of blue light emitting elements is a direction substantially parallel to a main surface of the liquid crystal display panel.

(14) In the liquid crystal display device according to item (13) of the present invention, the light output direction is a direction substantially parallel to a longitudinal direction of the each of the plurality of fluorescent lamps.

(15) In the liquid crystal display device according to item (13) of the present invention, the light output direction is a direction substantially parallel to a direction in which the plurality of fluorescent lamps are arranged in parallel.

(16) In the liquid crystal display device according to item (1) of the present invention, a light output direction of at least one of the plurality of blue light emitting elements is a direction substantially parallel to a main surface of the liquid crystal display panel.

(17) The liquid crystal display device according to item (1) of the present invention further includes a reflection sheet disposed above the housing on a side of the liquid crystal display panel, and each of the plurality of blue light emitting elements is disposed between the housing and the reflection sheet.

(18) In the liquid crystal display device according to item (17) of the present invention, the reflection sheet has holes formed therein at portions opposed to the plurality of blue light emitting elements.

(19) In the liquid crystal display device according to item (17), the housing includes a protrusion which protrudes on an opposite side to the liquid crystal display panel, and each of the plurality of blue light emitting elements is disposed at the protrusion on a side of the liquid crystal display panel.

Note that the structures described above are merely examples, and modifications may be made to the present invention as appropriate without departing from the technical concept of the present invention. Further examples of the structure of the present invention other than the structures described above become apparent from the entire description of the specification of the present application or the accompanying drawings.

According to the liquid crystal display device having the structure described above, the yellowing may be prevented from occurring in white color tone of the backlight.

Further advantages of the present invention become apparent from the entire description of the specification.

### BRIEF DESCRIPTION OF THE DRAWINGS

In the accompanying drawings:

FIG. 1A and FIG. 1B are structural views each illustrating a backlight of a liquid crystal display device according to Embodiment 1 of the present invention;

FIG. 2 is a plan view in an exploded state illustrating the liquid crystal display device according to Embodiment 1 of the present invention;

FIG. 3 is a cross-sectional view illustrating a backlight of a liquid crystal display device according to Embodiment 2 of the present invention;

FIG. 4A is a plan view illustrating a backlight of a liquid crystal display device according to Embodiment 3 of the present invention;

FIG. 4B is a configuration diagram of a control circuit for the backlight of the liquid crystal display device according to Embodiment 3 of the present invention;

FIG. 5 is a configuration diagram of a control circuit for a backlight of a liquid crystal display device according to Embodiment 4 of the present invention;

FIG. 6 is a view illustrating light output directions of blue light emitting elements in a liquid crystal display device according to Embodiment 7 of the present invention;

FIG. 7 is a view illustrating light output directions of blue light emitting elements different from those used in FIG. 6 in the liquid crystal display device according to Embodiment 7 of the present invention;

FIG. 8 is a cross-sectional view of a backlight of a liquid crystal display device according to Embodiment 8 of the present invention; and

FIG. 9 is a view illustrating a shape of a frame of the liquid crystal display device according to Embodiment 8 of the present invention.

### DETAILED DESCRIPTION OF THE INVENTION

Referring to the accompanying drawings, embodiments of the present invention are described. Note that throughout the drawings and the embodiments, the same or similar components are denoted by the same reference symbols, and repetitive description thereof is omitted.

### Embodiment 1

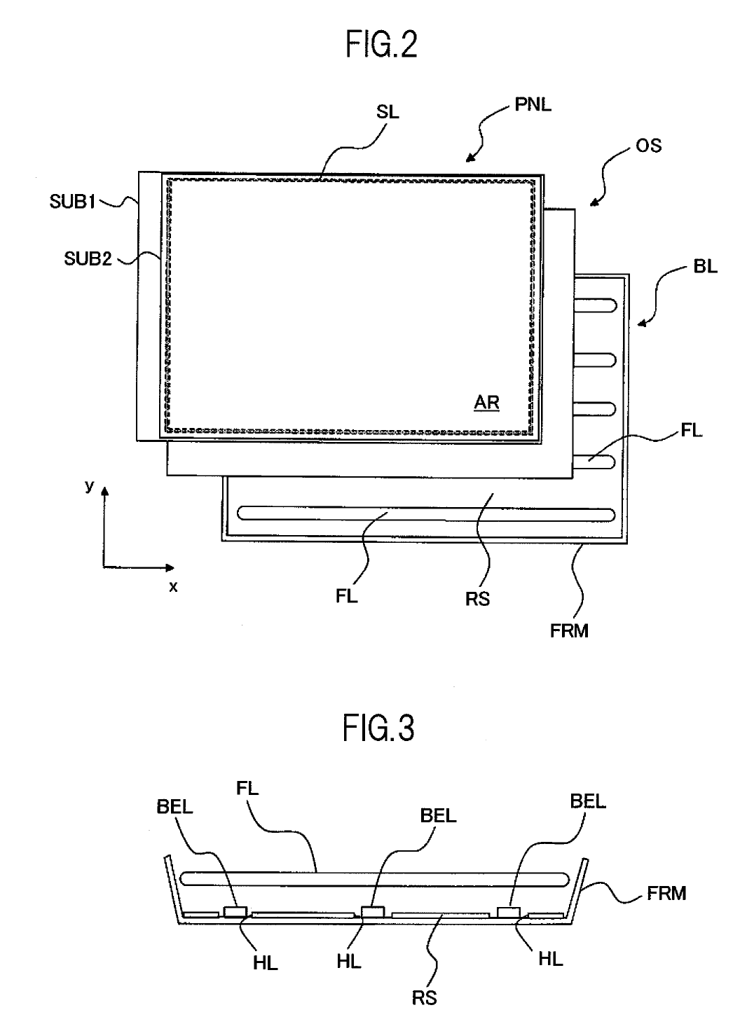

FIG. 2 is a plan view illustrating a liquid crystal display device according to Embodiment 1 of the present invention in an exploded state.

The liquid crystal display device includes a liquid crystal display panel PNL, an optical sheet OS, and a backlight BL that are arranged in the stated order from a viewer side (front side of the sheet).

The liquid crystal display panel PNL constitutes a package by including a substrate SUB1 and a substrate SUB2 that are arranged opposed to each other with liquid crystal sandwiched therebetween. The substrate SUB1 and the substrate SUB2 adhere to each other by a seal member SL that is formed in the periphery of the substrate SUB1 and the substrate SUB2 to have a ring-like shape. The seal member SL has another function of sealing the liquid crystal within the seal member SL. An area surrounded by the seal member SL defines a display area AR. On liquid crystal side surfaces of the substrate SUB1 and the substrate SUB2 within the display area AR, a plurality of pixels (not shown), each of which includes the liquid crystal as a component of the pixel, are formed in matrix. Light transmittances of the pixels are individually controlled.

As the optical sheet OS, for example, a prism sheet, a diffusion sheet, or a laminated sheet of the prism sheet and the diffusion sheet is used. The optical sheet OS condenses or diffuses light from the backlight BL described below so that the light may be guided to the liquid crystal display panel PNL side.

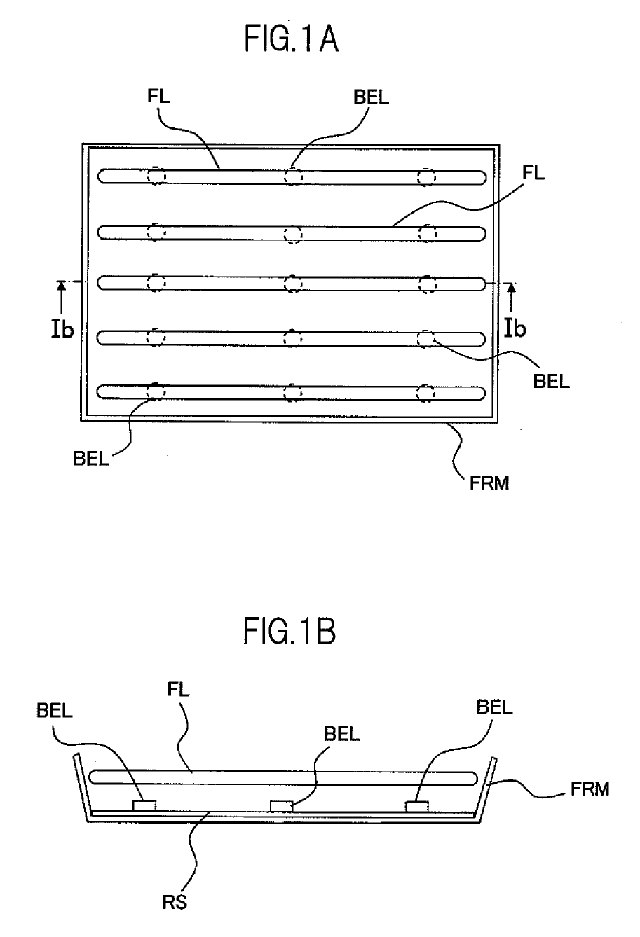

The backlight BL includes a plurality of (for example, five in FIG. 2) cold cathode fluorescent lamps FL arranged in parallel in a plane parallel to the liquid crystal display panel PNL. The cold cathode fluorescent lamps FL are arranged in parallel, for example, with equal intervals in the y direction of FIG. 2 so that respective tube axes may be aligned in, for example, the x direction of FIG. 2. The cold cathode fluorescent lamps FL are each supported to a frame (housing) FRM via a support member (not shown). The frame FRM is disposed opposed to the liquid crystal display panel PNL. The cold cathode fluorescent lamp FL is allowed to emit light when supplied with power from electrodes (not shown) formed at both ends of the cold cathode fluorescent lamp FL. Further, a reflection sheet RS (see FIG. 1B) is disposed on a surface of the frame FRM, which is located on the lower side of the cold cathode fluorescent lamp FL of FIG. 1B, so as to cover the frame FRM. The reflection sheet RS allows light emitted from the cold cathode fluorescent lamp FL to the frame FRM side to be reflected to the liquid crystal display panel PNL side.

Note that the above-mentioned liquid crystal display panel PNL, optical sheet OS, and backlight BL form a module by using an upper frame (not shown), an intermediate frame (not shown), and the frame FRM (lower frame), to thereby constitute the liquid crystal display device.

Although not illustrated in FIG. 2, the backlight BL further includes blue light emitting elements BEL serving as other light sources than the cold cathode fluorescent lamps FL. FIG. 1A is a plan view focusing on the backlight BL illustrated in FIG. 2. FIG. 1B is a cross-sectional view taken along the line Ib-Ib of FIG. 1A.

In FIG. 1A and FIG. 1B, the blue light emitting elements BEL are arranged on the reflection sheet RS, and arranged so as to be overlapped with the respective cold cathode fluorescent lamps FL when viewed in plan. For each cold cathode fluorescent lamp FL, three blue light emitting elements BEL are arranged in, for example, the vicinity of one end, substantially the center, and the vicinity of another end of the each cold cathode fluorescent lamp FL. This way, the blue light emitting elements BEL may be arranged in a light source plane of the backlight BL so as to be scattered substantially uniformly.

During applying current, the cold cathode fluorescent lamp FL is affected by ultraviolet rays or heat generated from the cold cathode fluorescent lamp FL, to eventually cause yellowing in white color tone as described above. In view of this, when turned on, the blue light emitting element BEL has a function of allowing the yellowing of the cold cathode fluorescent lamp FL to be canceled with blue light to thereby realize white light.

For the purpose of this function, in order to obtain excellent effect of canceling the yellowing of the cold cathode fluorescent lamp FL with the aid of the blue light emitting element BEL, the blue light emitting elements BEL are preferred to be arranged as close to the cold cathode fluorescent lamp FL as possible. Therefore, as illustrated in FIG. 1A, when viewed in plan, the respective blue light emitting elements BEL are arranged below the cold cathode fluorescent lamps FL so as to be overlapped with the cold cathode fluorescent lamps FL. In this case, the blue light emitting element BEL may be disposed partially outside the cold cathode fluorescent lamp FL as long as the blue light emitting elements BEL are arranged to be overlapped with the cold cathode fluorescent lamp FL.

### Embodiment 2

FIG. 3 is a cross-sectional view illustrating a backlight BL of a liquid crystal display device according to Embodiment 2 of the present invention, from the same point of view as in FIG. 1B.

As compared to the case of FIG. 1B, the backlight BL illustrated in FIG. 3 is different in structure in that the blue light emitting elements BEL are each disposed on an upper surface of the frame FRM, and that the reflection sheet RS, which is disposed so as to cover the frame FRM, has holes HL formed therein at portions opposed to the blue light emitting elements BEL.

Even if there is no choice but to dispose the blue light emitting element BEL directly on the frame FRM, the structure described above enables the light of the blue light emitting element BEL to be emitted to the cold cathode fluorescent lamp FL side without being blocked by the reflection sheet RS, to thereby cancel the yellowing of the cold cathode fluorescent lamp FL.

### Embodiment 3

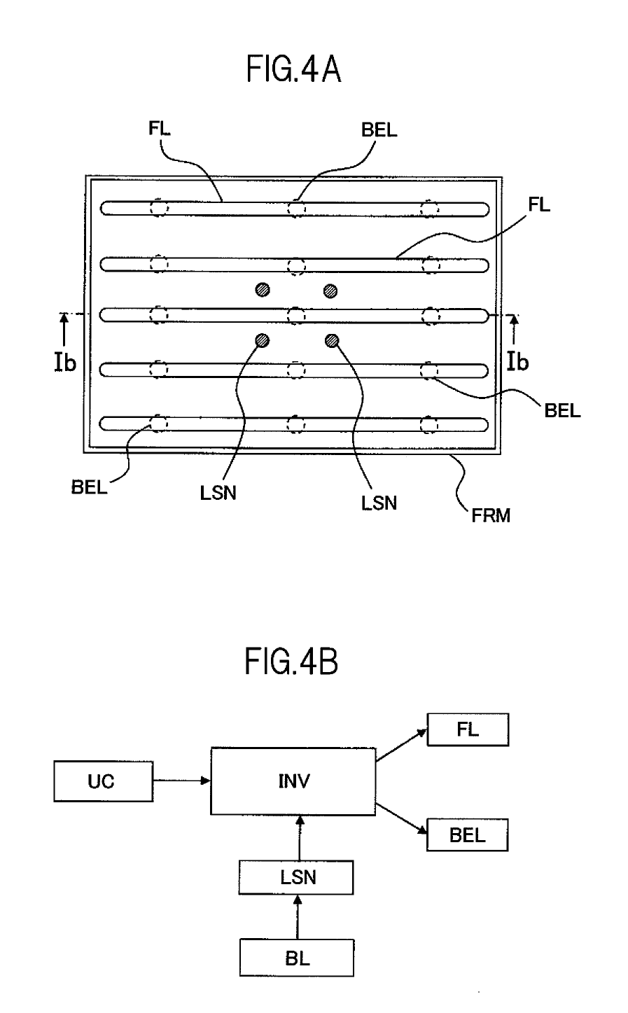

FIG. 4A is a plan view illustrating a backlight BL of a liquid crystal display device according to Embodiment 3 of the present invention, from the same point of view as in FIG. 1A.

As compared to the case of FIG. 1A, first, the backlight BL illustrated in FIG. 4A is different in structure in that the backlight BL includes optical sensors LSN capable of detecting color of light, which are arranged at substantially the center of the backlight BL. For example, four optical sensors LSN are arranged in proximity to one another at positions where the cold cathode fluorescent lamp FL is not disposed. Those optical sensors LSN are each configured to detect color of light as a mixture of the light from the cold cathode fluorescent lamp FL and the light from the blue light emitting element BEL. For example, a value determined by averaging respective outputs of the four optical sensors LSN is set as a detection value of the color. When yellow is detected based on the detection value obtained by the optical sensors LSN, a light emission amount of the blue light emitting element BEL is controlled in accordance with the detection value so that the color of light as a mixture of the light from the cold cathode fluorescent lamp FL and the light from the blue light emitting element BEL may consequently be as white.

FIG. 4B is a configuration diagram for illustrating the control of light emission amount of the blue light emitting element BEL performed in accordance with the detection value of the optical sensors LSN.

A circuit illustrated in FIG. 4B includes an inverter INV (control circuit) for controlling a light emission amount (luminance) of the cold cathode fluorescent lamp FL in response to, for example, input means UC set by a user. To drive the cold cathode fluorescent lamp FL, a pulse width modulation (PWM) method is employed, which is performed through setting of a duty ratio of high frequency voltage. The PWM method is, for example, a modulation method of varying a duty ratio of a pulse wave. The duty ratio refers to a ratio of a pulse width to a cycle of when a periodical pulse wave is applied. The cold cathode fluorescent lamp FL is turned on through the high frequency driving. Accordingly, if the high frequency voltage is intermittently applied with time, a ratio of a period τ during which the high frequency voltage is applied to a cycle T of the application (that is, τ/T) corresponds to the duty ratio of the high frequency voltage. When the high frequency voltage is applied to the cold cathode fluorescent lamp FL while the duty ratio is varied, the cold cathode fluorescent lamp FL is allowed to be turned on with luminance corresponding to the duty ratio.

Similarly to the cold cathode fluorescent lamp FL, the blue light emitting element BEL is also driven, for example, in accordance with a duty ratio of high frequency voltage. Specifically, the optical sensor LSN detects the light from the backlight BL (light from the cold cathode fluorescent lamp FL and the blue light emitting element BEL), and delivers the detection value to the inverter INV. The inverter INV sets a duty ratio of high frequency voltage corresponding to the detection value, and applies the high frequency voltage having the set duty ratio to the blue light emitting element BEL. The light emission amount of the blue light emitting element BEL corresponding to the duty ratio of the high frequency voltage acts on the yellowing occurring in the cold cathode fluorescent lamp FL so that the yellowing may be suppressed to realize white light.

According to the liquid crystal display device having the structure described above, the yellowing of the cold cathode fluorescent lamp FL may be suppressed automatically. Therefore, even if the cold cathode fluorescent lamp FL is affected by ultraviolet rays or heat generated therefrom, white light may be obtained all the time as the light from the backlight BL.

### Embodiment 4

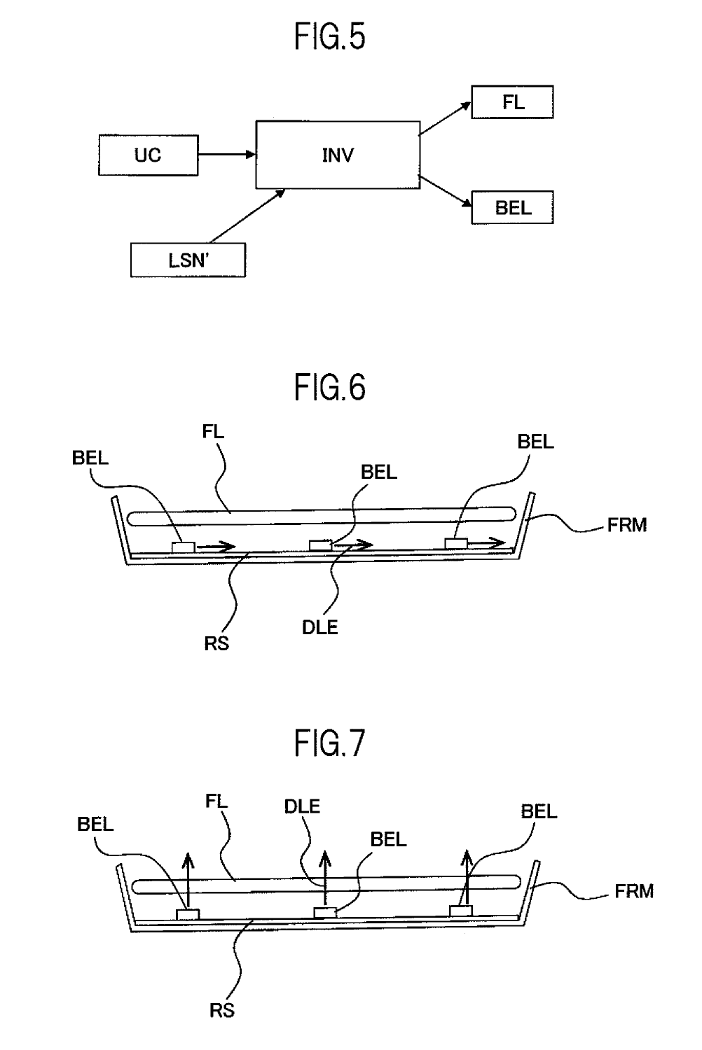

FIG. 5 is a configuration diagram for illustrating a control of light emission amount of the blue light emitting element BEL performed in a liquid crystal display device according to Embodiment 4 of the present invention, in a corresponding manner to FIG. 4B.

As compared to the case of FIG. 4B, a difference in configuration of FIG. 5 first resides in that the backlight BL is not provided with the optical sensor LSN as illustrated in FIG. 4A. Then, if the need arises, the inverter INV may be connected with an optical sensor LSN′. The optical sensor LSN′ is capable of detecting, for example, the light having passed through the liquid crystal display panel PNL from the backlight BL. After the inverter INV has been connected with the optical sensor LSN′, the inverter INV performs the same operation as in the liquid crystal display device according to Embodiment 3 of the present invention. With the configuration described above, in this embodiment, the adjustment to the duty ratio for the blue light emitting element BEL is enabled while the monitoring is performed on the user side, if the need arises.

### Embodiment 5

In the embodiments described above, the liquid crystal display panel PNL may be for color display as well as for monochrome display. In this case, the present invention is significantly effectively applied to the liquid crystal display panel PNL for monochrome display. The reason is as follows. In the case of the liquid crystal display panel PNL for color display, the yellowing of the cold cathode fluorescent lamp FL may be suppressed by, for example, a method of changing gradients of pixels of red (R), green (G), and blue (B), which are three primary colors for color display. However, in the case of the liquid crystal display panel PNL for monochrome display, because the method described above cannot be employed, the yellowing has to be suppressed only by the light from the backlight BL.

### Embodiment 6

In each of the embodiments described above, the cold cathode fluorescent lamp is used as the light source of the backlight BL. However, the light source is not limited to the cold cathode fluorescent lamp, and the present invention is also applicable to the case of other fluorescent lamps. This is because other fluorescent lamps than the cold cathode fluorescent lamp are also affected by ultraviolet rays or heat generated therefrom, and thus have such a tendency that yellowing occurs in white color tone.

### Embodiment 7

In each of the embodiments described above, as the blue light emitting element BEL, not only a side-emission type light emitting diode (LED) but also a top-emission type light emitting diode (LED) may be used.

FIG. 6 is a view illustrating light output directions DLE of the blue light emitting elements BEL in the case where the side-emission type light emitting diodes (LEDs) are used as the blue light emitting elements BEL. In FIG. 6, the light output direction DLE of the blue light emitting element BEL is a direction substantially parallel to a main surface of the liquid crystal display panel PNL (not shown) (see FIG. 2).

In FIG. 6, because the light output direction DLE is the direction substantially parallel to the main surface of the liquid crystal display panel PNL, the light of the blue light emitting element BEL is prevented from being emitted directly to the liquid crystal display panel PNL side. With the structure described above, an area in which blue is enhanced is prevented from locally appearing in the display area AR of the liquid crystal display panel PNL. As a result, natural color change may be realized, and hence the stronger effect of canceling the yellowing of the cold cathode fluorescent lamp FL can be obtained.

Therefore, in each of the embodiments described above, as the blue light emitting element BEL, it is desirable to use the side-emission type light emitting diode (LED) that emits light in the direction substantially parallel to the main surface of the liquid crystal display panel PNL. As long as being of the side-emission type, other light emitting elements than the light emitting diode (LED) may be used without any problems.

Note that the light output direction DLE of the blue light emitting element BEL may be not only a direction substantially parallel to a longitudinal direction of the cold cathode fluorescent lamp FL, but also a direction in which the plurality of cold cathode fluorescent lamps FL are disposed one by one. In addition, the above-mentioned effect can be obtained even if a part of the plurality of blue light emitting elements BEL are of the side-emission type.

FIG. 7 is a view illustrating light output directions DLE of the blue light emitting elements BEL in the case where the top-emission type light emitting diodes (LEDs) are used as the blue light emitting elements BEL. In FIG. 7, the light output direction DLE of the blue light emitting element BEL is a direction in which the liquid crystal display panel PNL (not shown) (see FIG. 2) is disposed.

Even in the case where the top-emission type light emitting diodes (LEDs) are used as illustrated in FIG. 7, the effect of canceling the yellowing of the cold cathode fluorescent lamp FL can be obtained. This is because, in each of the embodiments described above, when viewed in plan, the respective blue light emitting elements BEL are arranged below the cold cathode fluorescent lamps FL so as to be overlapped with the cold cathode fluorescent lamps FL. As long as being of the top-emission type, other light emitting elements than the light emitting diode (LED) may be used without any problems.

### Embodiment 8

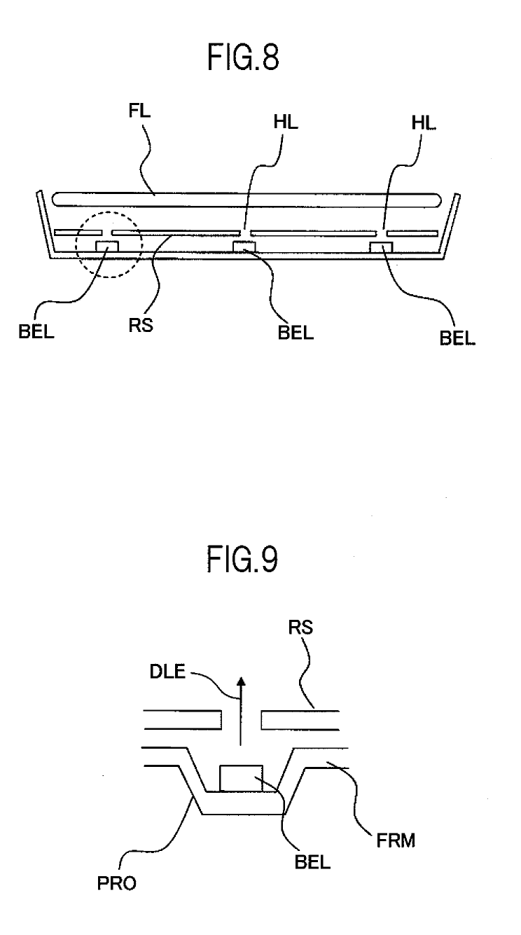

FIG. 8 is a cross-sectional view illustrating a backlight BL of a liquid crystal display device according to Embodiment 8 of the present invention, from the same point of view as in FIG. 1B.

In FIG. 8, the blue light emitting elements BEL are each disposed between the frame FRM and the reflection sheet RS. The reflection sheet RS has holes HL formed therein at portions opposed to the blue light emitting elements BEL. Note that the hole HL is not necessarily formed in the reflection sheet RS.

With the structure described above, an area in which blue is enhanced is prevented from locally appearing in the display area AR of the liquid crystal display panel PNL. As a result, natural color change may be realized.

Further, in the structure according to Embodiment 8 of the present invention, in the case where the top-emission type blue light emitting element BEL is used, the following structure may also be employed. That is, a protrusion PRO which protrudes on the opposite side to the liquid crystal display panel PNL is provided to the frame FRM, and the blue light emitting element BEL is disposed in a space defined by the protrusion PRO. FIG. 9 is an enlarged view of the portion surrounded by a dotted line of FIG. 8, illustrating the protrusion PRO described above.

With the structure described above, a wiring substrate (not shown) of the blue light emitting element BEL is hid to prevent reflection efficiency from being lowered due to the wiring substrate. Besides, the effect of dissipating heat generated from the blue light emitting element BEL can also be obtained.

The present invention has been described above by way of the embodiments. However, the structures described in the respective embodiments described above are merely examples, and modifications may be made to the present invention as appropriate without departing from the technical concept of the present invention. Besides, the structures described in the respective embodiments may be used in combination unless a contradiction arises therebetween.

While there have been described what are at present considered to be certain embodiments of the invention, it will be understood that various modifications may be made thereto, and it is intended that the appended claim cover all such modifications as fall within the true spirit and scope of the invention.

What is claimed is:

1. A liquid crystal display device, comprising:
a liquid crystal display panel which seals liquid crystal composition therein and controls orientations of the liquid crystal composition; and
a backlight disposed on a side of one surface of the liquid crystal display panel, for emitting light toward the liquid crystal display panel,
wherein the backlight including:
a plurality of fluorescent lamps arranged in parallel in a plane parallel to the liquid crystal display panel;
a housing for supporting each of the plurality of fluorescent lamps; and
a plurality of blue light emitting elements each disposed between the housing and the plane in which the plurality of fluorescent lamps are arranged in parallel, and
the plurality of blue light emitting elements are arranged at positions overlapped with the plurality of fluorescent lamps when projected onto a plane parallel to the plane in which the plurality of fluorescent lamps are arranged in parallel.

2. The liquid crystal display device according to claim 1, further comprising a reflection sheet disposed on a surface of the housing on a side of the liquid crystal display panel,
wherein each of the plurality of blue light emitting elements is disposed on the reflection sheet.

3. The liquid crystal display device according to claim 1, further comprising a reflection sheet disposed on a surface of the housing on a side of the liquid crystal display panel,
wherein each of the plurality of blue light emitting elements is disposed on the housing, and
wherein the reflection sheet has holes formed therein at portions opposed to the plurality of blue light emitting elements.

4. The liquid crystal display device according to claim 1, further comprising:
an optical sensor capable of detecting color of light having passed through the liquid crystal display panel from the backlight; and
a control circuit for controlling a light emission amount of each of the plurality of blue light emitting elements in accordance with an output of the optical sensor.

5. The liquid crystal display device according to claim 4, wherein the control circuit controls the light emission amount of the each of the plurality of blue light emitting elements through setting of a duty ratio of high frequency voltage.

6. The liquid crystal display device according to claim 4, wherein the control circuit controls a light emission amount of the each of the plurality of fluorescent lamps through setting of a duty ratio of high frequency voltage.

7. The liquid crystal display device according to claim 1, further comprising:
an optical sensor which is mounted on the housing and is capable of detecting color of light from the each of the plurality of fluorescent lamps; and
a control circuit for controlling a light emission amount of each of the plurality of blue light emitting elements in accordance with an output of the optical sensor.

8. The liquid crystal display device according to claim 7, wherein the control circuit controls the light emission amount of the each of the plurality of blue light emitting elements through setting of a duty ratio of high frequency voltage.

9. The liquid crystal display device according to claim 7, wherein the control circuit controls a light emission amount of the each of the plurality of fluorescent lamps through setting of a duty ratio of high frequency voltage.

10. The liquid crystal display device according to claim 1, wherein the liquid crystal display panel is a liquid crystal display panel for color display.

11. The liquid crystal display device according to claim 1, wherein the liquid crystal display panel is a liquid crystal display panel for monochrome display.

12. The liquid crystal display device according to claim 1, wherein a light output direction of each of the plurality of blue light emitting elements is a direction in which the liquid crystal display panel is disposed.

13. The liquid crystal display device according to claim 1, wherein a light output direction of each of the plurality of blue light emitting elements is a direction substantially parallel to a main surface of the liquid crystal display panel.

14. The liquid crystal display device according to claim 13, wherein the light output direction is a direction substantially parallel to a longitudinal direction of the each of the plurality of fluorescent lamps.

15. The liquid crystal display device according to claim 13, wherein the light output direction is a direction substantially parallel to a direction in which the plurality of fluorescent lamps are arranged in parallel.

16. The liquid crystal display device according to claim 1, wherein a light output direction of at least one of the plurality of blue light emitting elements is a direction substantially parallel to a main surface of the liquid crystal display panel.

17. The liquid crystal display device according to claim 1, further comprising a reflection sheet disposed above the housing on a side of the liquid crystal display panel,
wherein each of the plurality of blue light emitting elements is disposed between the housing and the reflection sheet.

18. The liquid crystal display device according to claim 17, wherein the reflection sheet has holes formed therein at portions opposed to the plurality of blue light emitting elements.

19. The liquid crystal display device according to claim 17,
wherein the housing comprises a protrusion which protrudes on an opposite side to the liquid crystal display panel, and
wherein the each of the plurality of blue light emitting elements is disposed at the protrusion on the side of the liquid crystal display panel.
